(19) United States
(12) Patent Application Publication
(10) Pub. No.: US 2017/0270833 A1
(43) Pub. Date: Sep. 21, 2017

(54) Dissolvable Tags

(71) Applicants: Lauryn Dill, Ann Arbor, MI (US); Avani Guduri, Ann Arbor, MI (US); Elizabeth Hook, Ann Arbor, MI (US); Hana Kaehr, Ann Arbor, MI (US); Eleanor Lin, Ann Arbor, MI (US); Natalie Mycek-Card, Ann Arbor, MI (US); Bella Patel, Ann Arbor, MI (US); Pranavi Pratapa, Ypsilanti, MI (US); Jordan Reeves, Saline, MI (US); Laurea Wright, Ann Arbor, MI (US)

(72) Inventors: Lauryn Dill, Ann Arbor, MI (US); Avani Guduri, Ann Arbor, MI (US); Elizabeth Hook, Ann Arbor, MI (US); Hana Kaehr, Ann Arbor, MI (US); Eleanor Lin, Ann Arbor, MI (US); Natalie Mycek-Card, Ann Arbor, MI (US); Bella Patel, Ann Arbor, MI (US); Pranavi Pratapa, Ypsilanti, MI (US); Jordan Reeves, Saline, MI (US); Laurea Wright, Ann Arbor, MI (US)

(21) Appl. No.: 15/071,918

(22) Filed: Mar. 16, 2016

(51) Int. Cl. G09F 3/02; G06K 19/06; G09F 3/14; G06K 19/02

(52) U.S. Cl. CPC G09F 3/02; G06K 19/025; G06K 19/06028; G09F 3/14; G09F 2003/0208; G09F 2003/0255; G09F 2003/0282

(57) ABSTRACT

A dissolvable tag includes a substrate and ink printed on the substrate that provides information. Both the ink and the substrate are water-soluble.

### FIELD

The present disclosure relates to dissolvable tags.

### BACKGROUND

The statements in this section merely provide background information related to the present disclosure and may not constitute prior art.

Billions of articles of clothing are purchased every year. Typically, an article of clothing in a store has one or more tags attached to it. The tags may indicate the price, color and brand name of the garment. When a consumer purchases the article of clothing and takes it home, the tags are removed and thrown away. Some clothing manufacturers make clothing tags from recycled paper. Nonetheless, the recycled tags are eventually thrown away. Estimates indicate that discarded clothing tags produce thousands of tons of waste annually in the United States.

Accordingly, there is a need for clothing tags that are economical and that benefit the environment.

### SUMMARY

A dissolvable tag includes a substrate and ink printed on the substrate that provides information. The ink and the substrate are both water-soluble. The dissolvable tag may be further characterized by one or any combination of the features described herein, such as: a water-soluble attachment mechanism that attaches the dissolvable tag to an article of clothing; the attachment mechanism is a filament; the substrate is made of soap; the dissolvable tag dissolves in water from about 1 minute to about 3 minutes; the ink is a plant-based ink; a protective film that encases the substrate; and the protective film is made of polyvinyl alcohol.

Pursuant to yet another aspect, there is contemplated a method of making dissolvable tags. The method includes forming a water-soluble substrate, printing information on the substrate, and encasing the substrate in a water-soluble protective film. The method may be further characterized by one or any combination of the following steps: forming the water-soluble substrate includes pouring melted soap into a mold to form a soap sheet; printing information includes printing with a plant-based ink; threading an attachment mechanism to the substrate and protective film; the protective film is made of polyvinyl alcohol; and printing information includes making indents with an embossing tool.

Further features, advantages, and areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way. The components in the figures are not necessarily to scale, emphasis instead being placed upon illustrating the principles of the invention. In the drawings:

FIG. 1 is a perspective view of a dissolvable tag in accordance with principles of the present invention;

FIG. 2 is a cross-sectional view of the dissolvable tag shown in FIG. 1;

FIG. 3A illustrates an article of clothing with a conventional tag;

FIG. 3B illustrates an article of clothing with the dissolvable tag shown in FIG. 1; and

FIG. 4 is a flow diagram of a process to produce the dissolvable tag in accordance with the principles of the present invention.

### DETAILED DESCRIPTION

The following description is merely exemplary in nature and is not intended to limit the present disclosure, application, or uses.

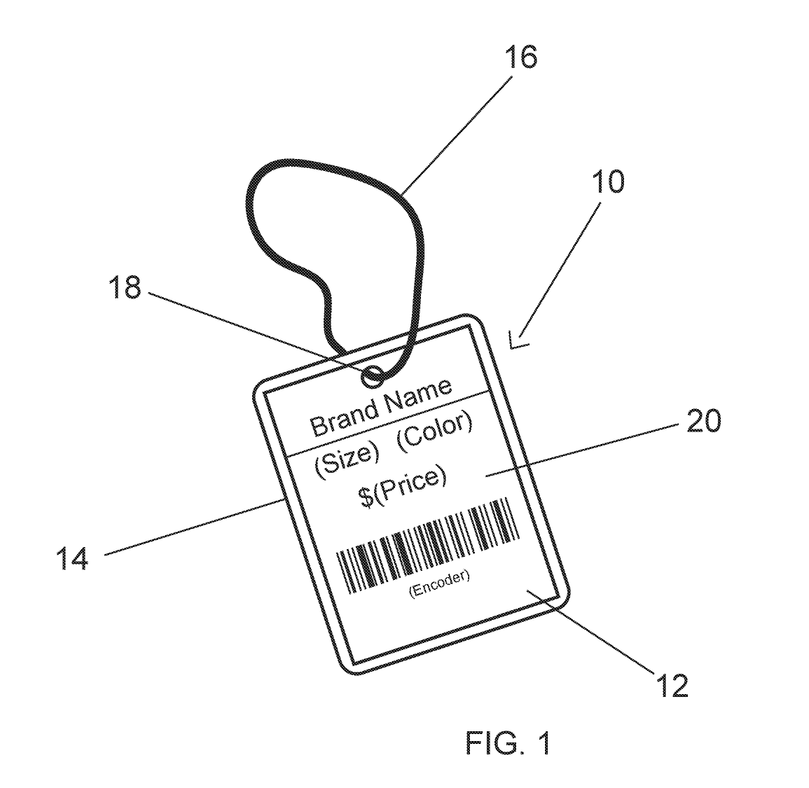

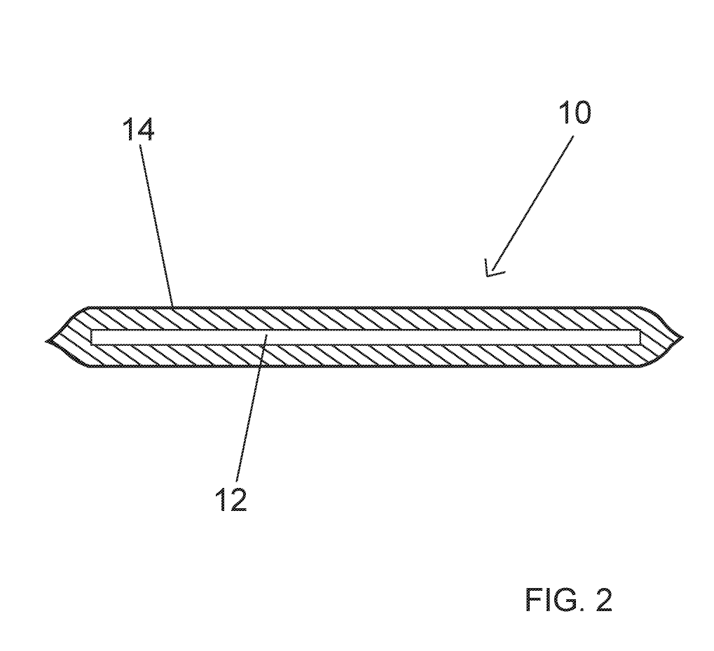

Referring now to FIGS. 1 and 2, a dissolvable tag or label embodying the principles of the present invention is illustrated therein and designated at 10. When attached to an article of clothing or a piece of garment as described below, one or more dissolvable tags 10 provide information about the article of clothing, such as, for example, the size, color, price and brand name.

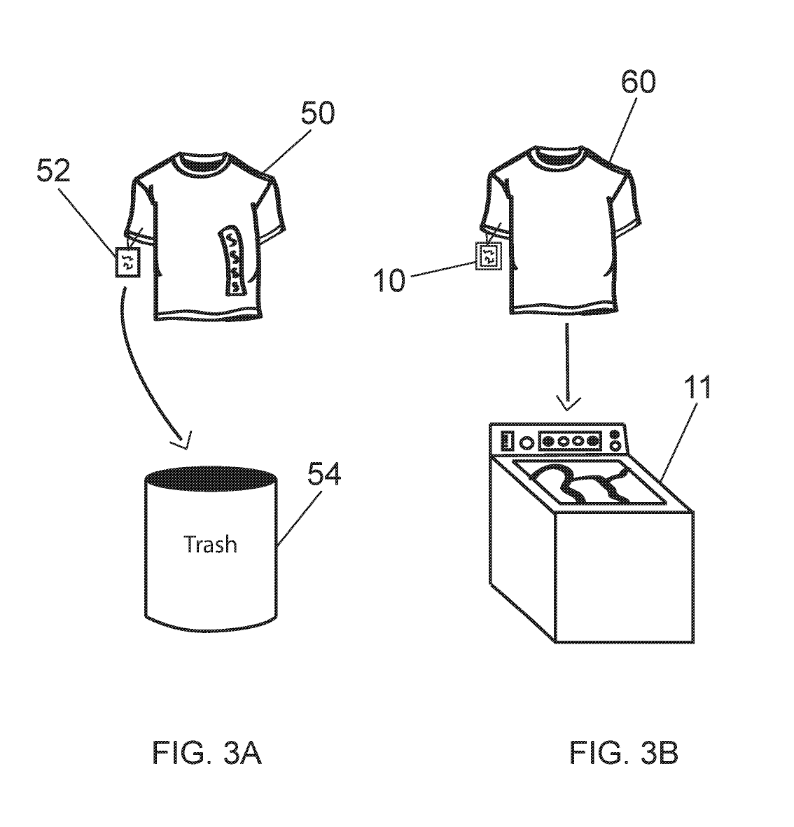

Typically, as shown in FIG. 3A, an article of clothing 50 has one or multiple tags 52 attached to it. Prior to washing the article of clothing 50, the tags 52 are removed from and disposed into the trash 54. In contrast and in accordance with the principles of the present invention, when one or more dissolvable tags 10 are attached to an article of clothing 60 as shown in FIG. 3B, both the dissolvable tag 10 and the article of clothing 60 are placed together in a washing machine 11. The dissolvable tag 10 dissolves in water and adds to or replaces the soap normally used to wash the article of clothing 60.

Referring back to FIG. 2, the dissolvable tag includes a substrate 12 and an optional film layer 14. A dissolvable string or filament may be threaded through a hole 18 to enable attaching the dissolvable tag 10 to an article of clothing. Alternatively, any other suitable attachment mechanism may be employed to attach the tag 10 to the article of clothing.

The substrate 12 is made of a water-soluble material, such as, for example, soap sheets. The string or filament 16 is water-soluble as well. In various implementations, the substrate 12 along with the attachment mechanism, such as, the string or filament 16, dissolve in water within a few minutes, for example, between about 1 to 3 minutes. Hence, when the new article of clothing is being washed for the first time, the substrate 12 dissolves and produces a cleansing product to clean the article of clothing. Accordingly, the use of the dissolvable tags 10 eliminates waste associated with discarded clothing tags. Further, the dissolvable tags reduce the amount of soap needed to wash the article of clothing, or the dissolvable tags entirely replaces soap that would be used to clean the clothing. The dissolvable tag 10 can be used as hand soap as well.

In certain implementations, the dissolvable tags 10 are printed with information 20 such as a barcode to describe the article of clothing. The printed information may also describe the color, size, and price as well as the brand name of the article of clothing. The ink used for the printed information is in some implementations a washable non-toxic ink, such as, for example, a plant-based ink or dye that dissolves in water and does not stain the clothing material. Note, however, that in some implementations, the dye or ink can be used to stain the clothing if desired; that is, the dye or ink can be used to color the article of clothing in a desired color or with a desired pattern.

To enhance the durability of the dissolvable tag 10, the substrate 12 can be covered with a protective film 14 made from, for example, a polyvinyl alcohol material. The protective film 14 is a non-toxic film that dissolves in water along with the substrate 12. The protective film 14 provides an added benefit by preventing a child, for example, from accessing the soap material that forms the substrate 12.

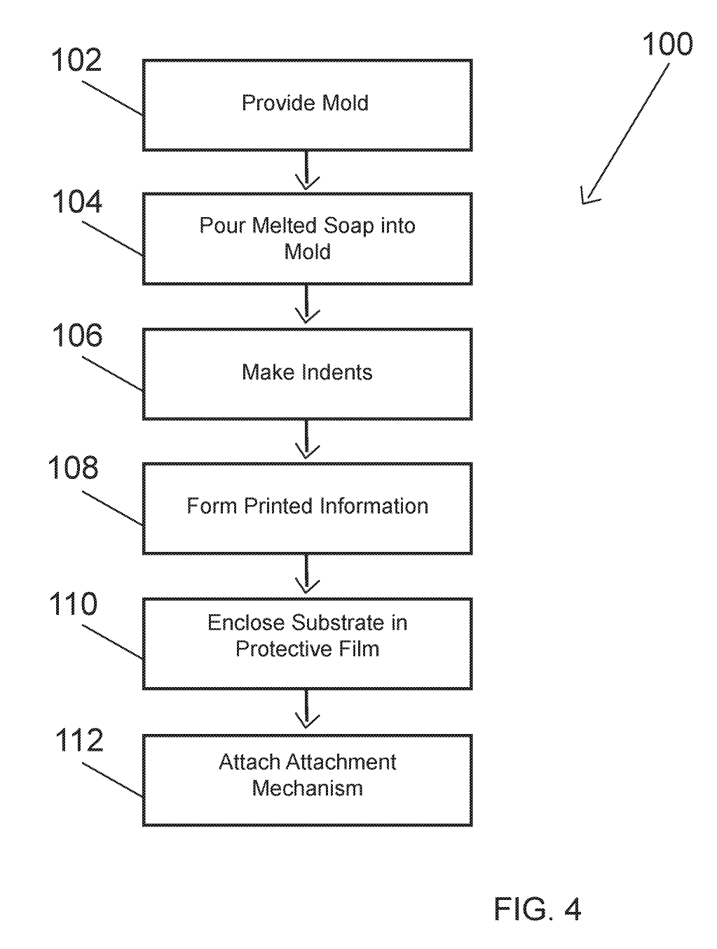

Referring now to FIG. 4, a process 100 to make the dissolvable tag 10 is illustrated. A mold is provided in a first step 102. Melted soap is then poured into the mold in step 104 to cast the substrate 12. After the soap sheet has hardened, an embossing tool is employed in step 106 to make indents in the substrate 12, for example, to carve out barcodes on the substrate 12. Then, in step 108, one or more colored inks or plant dyes are traced into the indents to form the printed information 20. Subsequently, in step 110, the substrate 12 is enclosed in the protective film 14, and, finally, the attachment mechanism, such as the string or filament 16 is threaded through or attached to the substrate 12 and protective film 14 in step 112.

In various implementations, the aforementioned mold is made of silicon. In a particular implementation, approximately one and a half tablespoon of soap is poured into a 3 inch by 2 inch mold to form the substrate 12. In an alternative implementation, soap sheets made, for example, by pressing are employed for the substrates 12. In certain implementations, the substrate 12 can be carved into the desired tag shape. In yet other implementations, the substrate 12 alone or the entire tag 10 can be formed with 3D printing technology.

In an alternative process, non-toxic dyes can be applied directly to the substrate 12 without the use of an embossing tool to form the printed information 20 before the soap sheets are enclosed in the protective film 14. In yet another alternative process, soap is melted and colored with a dye and then spread into the indents formed by the embossing process. Alternatively, washable markers can be employed to print information on the substrate 12.

The description of the invention is merely exemplary in nature and variations that do not depart from the gist of the invention are intended to be within the scope of the invention. Such variations are not to be regarded as a departure from the spirit and scope of the invention.

What is claimed is:

1. A dissolvable tag comprising:
a substrate; and
an ink printed on the substrate providing information, the substrate and the ink being water-soluble.

2. The dissolvable tag of claim 1 further comprising a water-soluble attachment mechanism that attaches the dissolvable tag to an article of clothing.

3. The dissolvable tag of claim 2 wherein the attachment mechanism is a filament.

4. The dissolvable tag of claim 1 wherein the substrate is made of soap.

5. The dissolvable tag of claim 1 wherein the dissolvable tag dissolves in water from about 1 minute to about 3 minutes.

6. The dissolvable tag of claim 1 wherein the ink is a plant-based ink.

7. The dissolvable tag of claim 1 further comprising a protective film that encases the substrate.

8. The dissolvable tag of claim 7 where the protective film is made of polyvinyl alcohol.

9. A dissolvable tag comprising:
a substrate with printed information;
a protective film encasing the substrate; and
an attachment mechanism that attaches the dissolvable tag to an article of clothing, the substrate, protective film and attachment mechanism being water-soluble.

10. The dissolvable tag of claim 9 wherein the attachment mechanism is a filament.

11. The dissolvable tag of claim 9 wherein the substrate is made of soap.

12. The dissolvable tag of claim 9 wherein the dissolvable tag dissolves in water from about 1 minute to about 3 minutes.

13. The dissolvable tag of claim 9 wherein the printed information is made from a plant-based ink.

14. The dissolvable tag of claim 9 where the protective film is made of polyvinyl alcohol.

15. A method of making a dissolvable tag, the method comprising:
forming a water-soluble substrate;
printing information on the substrate; and
encasing the substrate in a water-soluble protective film.

16. The method of claim 15 wherein forming the water-soluble substrate includes pouring melted soap into a mold to form a soap sheet.

17. The method of claim 15 wherein printing information includes printing with a water-soluble plant-based ink.

18. The method of claim 15 further comprising threading an attachment mechanism to the substrate and protective film.

19. The method of claim 15 wherein the protective film is made of polyvinyl alcohol.

20. The method of claim 15 wherein printing information includes making indents with an embossing tool.
